(19) United States
(12) Patent Application Publication
(10) Pub. No.: US 2024/0246620 A1
(43) Pub. Date: Jul. 25, 2024

(54) FIXATION SYSTEM AND DEVICE FOR AN ARTICULATING FIFTH WHEEL TOP PLATE

(71) Applicant: Thinking Cap, LLC, Roswell, NM (US)

(72) Inventors: Ernest Urquides, Roswell, NM (US); Ronald Church, Roswell, NM (US)

(73) Assignee: Thinking Cap, LLC, Roswell, NM (US)

(21) Appl. No.: 18/419,333

(22) Filed: Jan. 22, 2024

Related U.S. Application Data
(60) Provisional application No. 63/440,351, filed on Jan. 20, 2023.

(51) Int. Cl. B62D 53/08

(52) U.S. Cl. CPC B62D 53/0871; B62D 53/0842

(57) ABSTRACT

Disclosed herein is an articulating fifth wheel fixation device that includes a tube and a shaft. The tube includes a slot disposed along the length of the tube. The shaft is positioned inside a hollow portion of the tube. The shafts include a handle attached to a first end of the shaft. The shaft extends outward beyond the outer circumferential edge of the tube through the slot. Further discloses a pneumatic fifth wheel fixation system includes a compressor a pneumatic cylinder, a tube, and a shaft with the hand. The shaft is positioned inside a hollow portion of the tube. The shafts include a handle attached to a first end of the shaft. The shaft extends outward beyond the outer circumferential edge of the tube through the slot.

### PRIORITY CLAIM

This application claims the benefit of and priority to U.S. Provisional Patent Application 63/440,351 filed on Jan. 20, 2023.

### TECHNICAL FIELD

The disclosure relates generally to a fixation system and device for an articulating fifth wheel top plate.

### BACKGROUND

Hitches have been used throughout the ages. Simply stated, a hitch connects a wagon, trailer or cart to a motor or power source. One of the first instances of using a hitch was connecting a wagon to an animal. To do this, two wagon shafts extending off the wagon were strapped to the animal usually by a type of saddle at a second end. When using two or more animals a single wagon shaft was connected to an animal's harness or yoke. In the case of oxen, two oxen would be placed in a yoke that has a pole ring connected to the yoke between the two oxen and the wagon shaft would be inserted into the pole ring. One or more chains would attach to the wagon at one end and to the yoke at the other. A similar concept was used with horses and mules. However, the horses were not connected together directly by the yoke but by their attachment to the wagon shaft.

When animal power was outmatched by the steam engine, train hitches or couplings came into existence. Train couplings were used to connect railway cars together which ultimately connected to the engine. Initially, rail cars were coupled together manually using mechanisms such as a buffer and chain or a lock and pin. Later semiautomatic couplers were used to connect rail cars using mechanisms such as the Janney coupler, patented in the late 1800s. This made coupling rail cars safer because the person coupling the rail cars does not need to be positioned between the cars to couple. Modifications of Janney couplers are still used today. The more advanced coupling system in rail cars is the automatic coupler. An example of an automatic coupler is a Tomlinson coupler.

In the late 1800s, right before the turn of the century, the tractor trailer was invented and used to haul a semitrailer. A semitrailer is a trailer that does not have a front axle. The front end of the semitrailer rests on the tractor trailer and the back end of the semitrailer rests on the back axle. Originally, the shape of the coupling device between the semitrailer and the tractor trailer was a full disk and appeared like a wheel. Because of its shape the coupler was named a fifth wheel. Modern-day fifth wheels are shaped like a horseshoe and receive a king pin attached to the semitrailer. The upper portion of the fifth wheel rests on the upper coupler plate of the semitrailer. One weakness with this connection was if the semitrailer was being pulled up an uneven steep grade the semitrailer may be positioned at such an angle compared to the tractor trailer that king pin or the fifth wheel could break. To help solve this problem an articulating fifth wheel was invented. The articulating fifth wheel helped this problem but presented some new difficulties. For example, when the upper coupler of a dump semitrailer articulates, it creates too much movement which can damage the connection, including breaking the king pin or breaking the fifth wheel. The solution was to block or lock the fifth wheel in place to keep it from articulating. One solution was to attach a pipe to the bottom of the tractor trailer coupler plate and have sleeves attached to the frame at a fixed height. To lock the fifth wheel into place a single rod was inserted through both the pipe and the sleeves. The downside of this setup is that the rod was heavy, dirty, and difficult to store. Also, because sleeves are set at a specific height, certain fenders inhibit the insertion of the rod because the height of the fenders overlaps the height of the sleeves. Other solutions have been to have stoppers on the four corners of the fifth wheel, but that requires walking around the vehicle to actuate all four stoppers.

### SUMMARY

Disclosed herein is an articulating fifth wheel fixation device that includes a tube and a shaft. The tube includes a slot disposed along the length of the tube. The shaft is positioned inside a hollow portion of the tube. The shaft includes a handle attached to a first end of the shaft. The shaft extends outward beyond the outer circumferential edge of the tube through the slot. Further discloses a pneumatic fifth wheel fixation system includes a compressor a pneumatic cylinder, a tube, and a shaft with the hand. The shaft is positioned inside a hollow portion of the tube. The shaft includes a handle attached to a first end of the shaft. The shaft extends outward beyond.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. The advantages of the present disclosure will become better understood with regard to the following description and accompanying drawings:

FIG. 1 illustrates a bottom view of a fixation system and device for an articulating fifth wheel top plate.

FIG. 2 illustrates a bottom view of an actuated fixation system and device for an articulating fifth wheel top plate.

FIG. 3 illustrates a front view of an unattached tube used in a fixation system and device for an articulating fifth wheel top plate.

FIG. 4 illustrates a front view of items used in a fixation system and device for an articulating fifth wheel top plate.

FIG. 5 illustrates an unattached tube used in a pneumatic fixation system and device for an articulating fifth wheel top plate.

FIG. 6 illustrates a top view of an actuated pneumatic fixation system and device for an articulating fifth wheel top plate.

FIG. 7 illustrates a side view of an attached fixation system and device for an articulating fifth wheel top plate.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

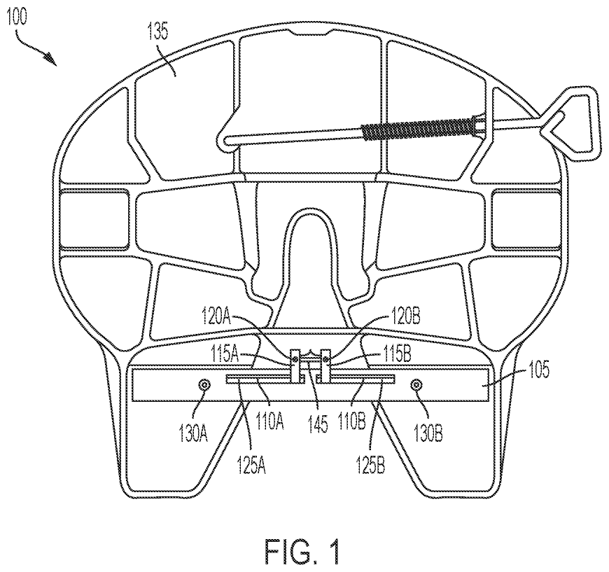

FIG. 1 illustrates a bottom view of a fixation system and device 100 for articulating fifth wheel top plate 135. Tube 105 may be attached to top plate 135 along the bottom side of top plate 135. One or more slots 110A-B may be disposed in tube 105 and slots 110A-B may extend along the length of tube 105. One end of slot 110A may begin near the middle of tube 105 and extend along the length of tube 105 towards a first end of tube 105. One end of slot 110B may begin near the middle of tube 105 and extend along the length of tube 105 towards a second end of tube 105. Grease fittings 130A-B may be attached to tube 105. For example, grease fitting 130A may be attached closer to a first end of tube 105 and grease fitting 130B may be attached closer to a second end of tube 105. Grease fittings 130A-B may be positioned as to be accessible to a grease gun or other grease application apparatuses while being in a position that does not hinder the operations of fifth wheel plate 135.

The inside of tube 105 may be hollow which in turn may allow one or more shafts 125A-B to be positioned inside tube 105. The diameter of one or more shafts 125A-B may be sized to be less than the diameter of the hollow portion of tube 105 as to allow one or more shafts 125A-B to slide back and forth along the length of tube 105. One or more of handles 115A-B may be attached respectively to shafts 125A-B. For example, handle 115A may attached to a proximal end of shaft 125A. Similarly, handle 115B may attach to a proximal end of shaft 125B. Handles 115A-B may have a diameter that is less than the width of slots 110A and 110B allowing handles 115A-B to slide back and forth along the length of slots 110A-B respectively. Slots 110A-B may include deviating channels that extend in a direction that is different than along the length of tube 105. These deviating channels may help to maintain handles 115A-B in a stowed and/or an actuated position.

One or more of handles 115A-B may include attachment points 120A-B respectively disposed on handles 115A-B. Attachment points 120A-B may be an aperture disposed towards an end opposite the end that attaches to shaft 110A and 110B. Alternatively, attachment points 120A-B may include a ring attached to handles 115A-B. Additionally, attachment points 120A-B may include a groove disposed around the circumference of handles 115A-B. Moreover, attachment points 120A-B may use attachment pin 145 to attach handle 115A to handle 115B using an aperture, groove or other implementation known in the art, to help prohibit one or more shafts 125A-B from unintentionally deploying to an actuated position.

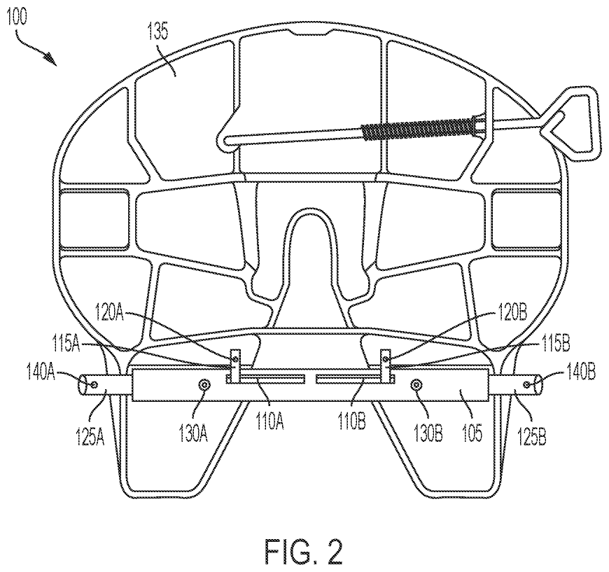

FIG. 2 illustrates a bottom view of an actuated fixation system and device 100 for articulating fifth wheel top plate 135. Tube 105 may be attached to a bottom portion of top plate 135. One or more of slots 110A-B may be disposed in tube 105 and extend along the length of tube 105. For example, one end of slot 110A may begin near the middle of tube 105 and extend along the length of tube 105 towards a first end of tube 105. One end of slot 110B may begin near the middle of tube 105 and extend along the length of tube 105 towards a second end of tube 105. Also, grease fittings 130A-B may be attached to tube 105. Grease fitting 130A may be attached closer to a first end of tube 105 and grease fitting 130B may be attached closer to a second end of tube 105. Grease fittings 130A-B may be positioned to be accessible to a grease gun or other greasing application apparatuses while being in a position that does not hinder the operations of fifth wheel plate 135.

The hollow portion of tube 105 may allow one or more shafts 125A-B to be positioned inside tube 105. The diameter of one or more shafts 125A-B may be sized to be less than the diameter of the hollow portion of tube 105. Shaft 125A may be positioned to slide towards a first end of tube 105. Similarly, shaft 125B may be positioned to slide towards a second end of tube 105. The diameter of shafts 125A-B may be sized to allow shafts 125A-B to slide back and forth along the length of tube 105. One or more of shafts 125A-B may include locking points 140A-B the purpose of which may help prohibit shafts 125A-B from unintentionally moving from an actuated position to a stowed position. Locking points 140A-B may include an aperture to insert a pin or a groove disposed around the circumference of one or more shafts 125A-B to receive a ring to prevent the sliding of shafts 125A-B. Another alternative to locking points 140A-B may be a spring-loaded leg that sits in a groove of shafts 125A-B and deploys outwardly from shaft 125A-B and once in an actuated position outside of tube 105 prevents the retraction of shafts 125A-B.

One or more of handles 115A-B may attach respectively to one or more of shafts 125A-B. For example, handle 115A may attach to a proximal end of shaft 125A. Similarly, handle 115B may attach to a proximal end of shaft 125B. Handles 115A-B may have a diameter that is less than the width of slots 110A and 110B allowing handles 115A-B to slide back and forth along the length of slots 110A-B respectively. Slots 110A-B may include deviating channels that extend in a direction that is different than along the length of tube 105. These deviating channels may help to maintain handles 115A-B in a stowed and/or an actuated position.

Handles 115A-B may include attachment points 120A-B respectively disposed on handles 115A-B. Attachment points 120A-B may be an aperture disposed towards an end opposite the end that attaches to slots 110A and 110B. Attachment points 120A-B may also include a ring attached to handles 115A-B to facilitate a connection between a ring on attachment point 120A to attachment point 120B. Handles 115A-B may include a groove disposed around the circumference of handles 115A-B. Attachment points 120A-B may attach handle 115A to handle 115B to help prohibit shafts 125A-B from unintentionally deploying to an actuated position.

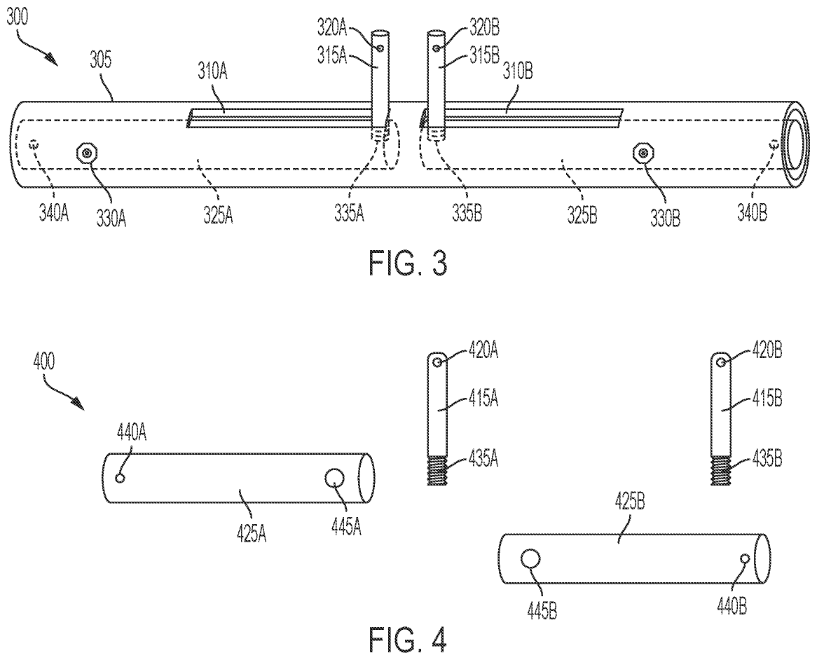

FIG. 3 illustrates a front view of an unattached tube 305 used in a fixation system and device 300 for an articulating fifth wheel top plate. Tube 305 may include slots 310A-B that may be disposed in tube 305 and extend along the length of tube 305. Also, grease fittings 330A-B may be attached to tube 305. Grease fitting 330A may be attached closer to a first end of tube 305 and grease fitting 330B may be attached closer to a second end of tube 305. Grease fittings 330A-B may be positioned to be accessible to a grease gun or other grease application apparatuses while being in a position that does not hinder the operations of a fifth wheel plate. The hollow inside portion of tube 305 may allow shafts 325A-B to be positioned inside tube 305. The diameter of shafts 325A-B may be sized to be less than the diameter of the hollow portion of tube 305. The diameter of shafts 325A-B may be sized to allow shafts 325A-B to slide back and forth along the length of tube 305. Shafts 325A-B may include locking points 340A-B. Locking points 340A-B may include an aperture to insert a pin. Alternatively, locking points 340A-B may include a groove disposed around the circumference of shafts 325A-B to receive a ring to prevent shafts 325A-B from sliding. Another alternative to locking points 340A-B may be a spring-loaded leg that sits in a groove of shafts 325A-B and deploys outward from shaft 325A-B once in an actuated position outside of tube 305.

Handle 315A may attach to a proximal end of shaft 325A. Similarly, handle 315B may attach to a proximal end of shaft 325B. Handles 315A-B may include connection ends 335A-B that may be threaded to the connection ends found in shafts 325A-B that may also be threaded. Further, handles 315A and 315B may include one or more extensions and/or loops that help the user grasp handles 315A and 315B to actuate. For example, an extension may be placed on one or more of handles 315A-B to help actuate from one or more sides of the fifth wheel.

Handles 315A-B may have a diameter that is less than the width of slots 310A and 310B allowing handles 315A-B to slide back and forth along the length of slots 310A-B respectively. Slots 310A-B may include deviating channels that extend in a direction that is different than along the length of tube 305. These deviating channels may help to maintain handles 315A-B in a stowed and/or an actuated position. Handles 315A-B may include attachment points 320A-B respectively disposed on handles 315A-B.

Attachment points 320A-B may be an aperture disposed towards an end opposite the end that attaches to shaft 310A and 310B. Attachment points 320A-B may also include a ring attached to handles 315A-B to facilitate the connection between handles 315A and 315B. Handles 315A-B may include a groove disposed around the circumference of handles 315A-B. Attachment points 320A-B may attach handle 315A to handle 315B to help prohibit shafts 325A-B from unintentionally deploying to an actuated position.

FIG. 4 illustrates an exploded view of items used in a fixation system and device 400 for an articulating fifth wheel top plate. The items include shafts 425A-B and handles 415 A-B. The diameter of shafts 425A-B may be sized to be less than the diameter of the hollow portion of a tube as depicted in FIG. 3. The diameter of shafts 425A-B may be sized to allow shafts 425A-B to slide back and forth within the hollow portion of a tube as depicted in FIG. 3. Shafts 425A-B may include locking points 440A-B. Locking points 440A-B may include an aperture to insert a pin. Alternatively, locking points 440A-B may include a groove disposed around the circumference of shafts 425A-B to receive one or more rings to prevent shafts 425A-B from moving to a stowed position once in an actuated position. Another alternative to locking points 440A-B may be a spring-loaded leg that sits in a groove of shafts 425A-B and deploys outward from shaft 425A-B once in an actuated position outside of a tube as depicted in FIG. 3.

Attached to shafts 425A-B may be handles 415A-B respectively. Handles may include connection end 435A-B that may be threaded to the threaded connection ends 445A-B found in shafts 425A-B. Alternatively, one or both of handles 415A and 415B may include one or more extensions and/or loops that help the user grasp handles 415A and/or 415B to actuate. For example, an extension may be placed on one or both of handles 415A-B to help actuate from one or more sides of the fifth wheel.

Handle 415A may attach to a proximal end of shaft 425A. Similarly, handle 415B may attach to a proximal end of shaft 425B. Handles 415A-B may have a diameter that is less than the width of the slots of a tube as depicted in FIG. 3 allowing handles 415A-B to slide back and forth along the length of the slots as depicted in FIG. 3 respectively. Handles 415A-B may include attachment points 420A-B respectively disposed on handles 415A-B. Attachment points 420A-B may be an aperture disposed towards an end opposite the end that attaches to shaft 425A and 425B. Also, attachment points 420A-B may include a ring attached to handles 415A-B. Alternatively, Attachment points 420A-B may include a groove disposed around the circumference of handles 415A-B. Attachment points 420A-B may attach handle 415A to handle 415B to help prohibit shafts 425A-B from unintentionally deploying to an actuated position.

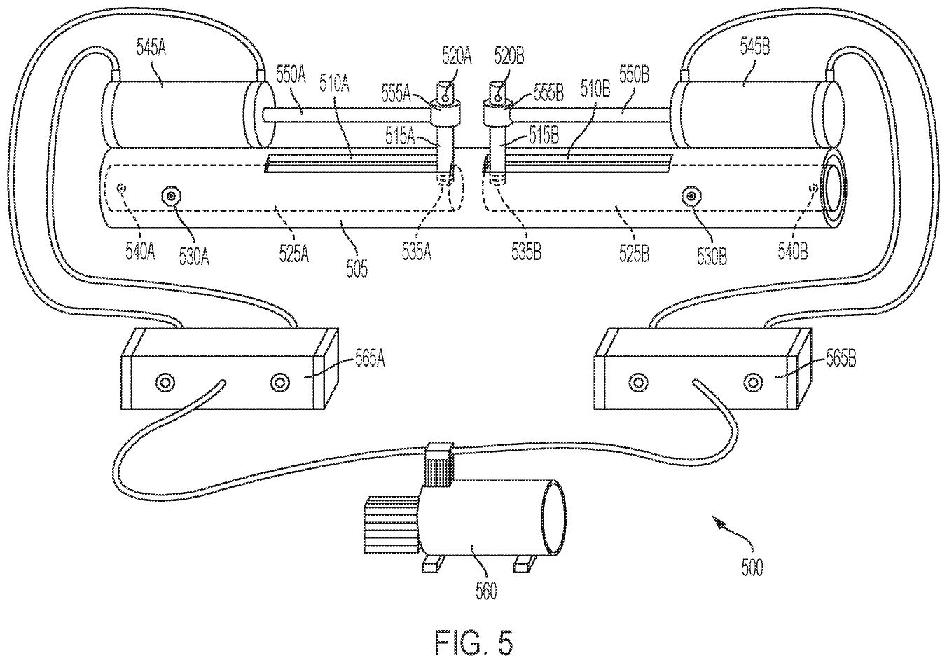

FIG. 5 illustrates an unattached tube used in a pneumatic fixation system and device 500 for an articulating fifth wheel top plate. Tube 505 may include slots 510A-B that may be disposed in tube 505 and extend along the length of tube 505. Slots 510A-B may be positioned such that the distance between the proximal ends of slots 510A-B to the center of tube 505 is less than the distance between the distal ends of slots 510A-B and the ends of tube 505.

Also, grease fittings 530A-B may be attached to tube 505. Grease fitting 530A may be attached closer to a first end of tube 505 and grease fitting 530B may be attached closer to a second end of tube 505. Grease fittings 530A-B may be positioned as to be accessible to a grease gun or other grease application apparatuses while being in a position that does not hinder the operations of the fifth wheel plate shown in FIGS. 1-2 and 6-7.

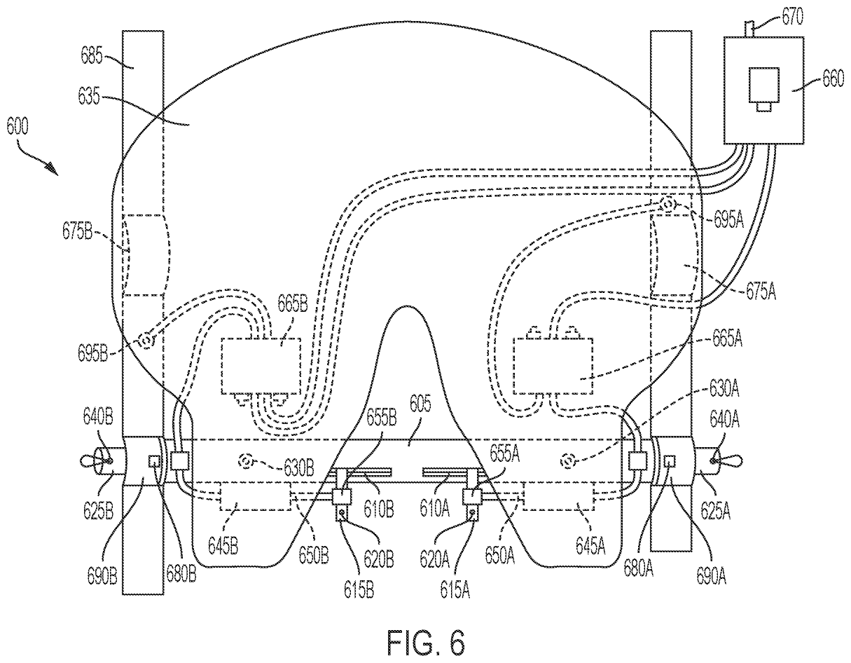

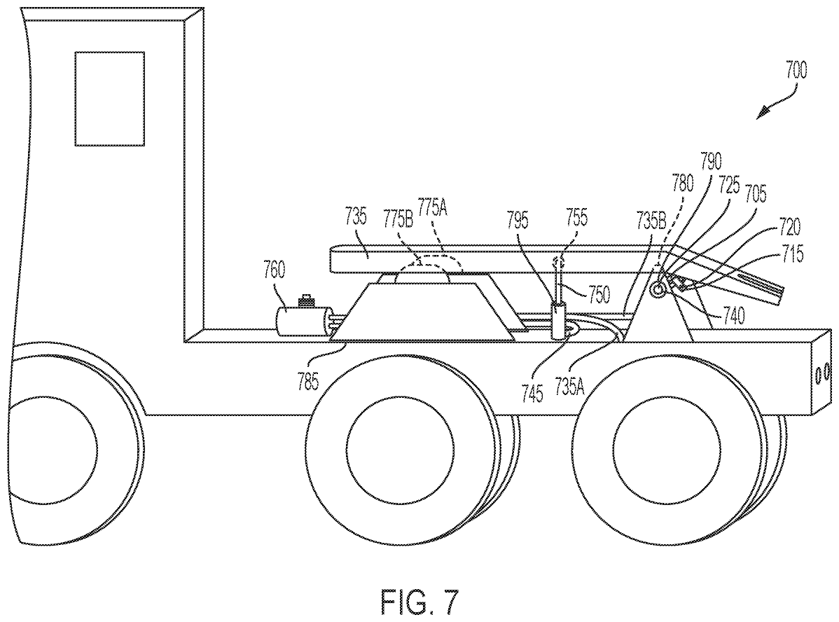

The hollow portion of tube 505 may allow shafts 525A-B to be positioned inside tube 505. The diameter of shafts 525A-B may be sized less than the diameter of the hollow portion of tube 505. The comparatively smaller diameter of shafts 525A-B may be sized to allow shafts 525A-B to slide back and forth along the length of tube 505. Shafts 525A-B may include locking points 540A-B. Locking points 540A-B, on shafts 525A-B, may be located on shafts 525A-B on an end opposite the end where handles 515A-B are attached to shafts 525A-B. Locking points 540A-B may include an aperture allowing a pin to be placed inside locking point 540A-B when shaft is positioned through a keeper (depicted at least in FIG. 6) to inhibit sliding. Alternatively, locking points 540A-B may include a groove disposed around the circumference of shafts 525A-B near an end of shafts 525A-B where a pin or ring is attachable. Locking points 540A-B may be used to secure couplings 555A-B to handles 515A-B to help prohibit couplings 555A-B from unintentionally moving to a stowed position. A stowed position in this context means moving one or more of shafts 525A-B from a keeper (keeper is depicted in FIGS. 6 and 7).

Attached to shafts 525A-B at an end opposite locking points 540A-B may be handles 515A-B respectively. Handles 515A-B may include connection end 535A-B that may be threaded to the connection ends found in shafts 525A-B that may also be threaded. The distal end of handles 515A-B may include attachment points 520A-B. Attachment points 520A-B are depicted as an aperture and can be used to link handle 515A and handle 515B. Attachment points 520A-B may be used to help keep couplings 555A-B in position on handles 520A-B. Couplings 555A-B may be connected to pneumatic cylinders 545A-B. Pneumatic cylinders 545A-B may connect to a first end of rod 550A-B respectively. The second end of rods 550A-B connect to couplings 555A-B that in turn connect to Handles 545A-B. Pneumatic cylinders 545A-B may further connect to port valves 565A-B by way of air hoses. Pneumatic cylinders 545A-B may be one or more of single-acting, double-acting, and telescopic cylinders. Port valves 565A-B may further connect to one or more air compressor 560 by way of air hoses.

Handle 515A may attach to a proximal end of shaft 525A. Similarly, handle 515B may attach to a proximal end of shaft 525B. Handles 515A-B may have a diameter that is less than the width of slots 510A and 510B allowing the handles 515A-B to slide back and forth along the length of slots 510A-B respectively. Slots 510A-B may include deviating channels that extend in a direction that is different than along the length of tube 505. These deviating channels may help to maintain handles 515A-B in a stowed and/or an actuated position.

In an alternate version of FIG. 5 air compressor 560 may be an electric motor that connects to one or more electric piston 548A-B. Electric motor 560 when activated may move one or more of shafts 525A-B into a locked or actuated position. Electric motor 560 may also be able to move one or more shafts 525A-B into an unlocked or stowed position.

In an alternate version of FIG. 5 air compressor 560 may be an hydraulic motor that connects to one or more hydraulic piston 548A-B. Hydraulic motor 560 when activated may move one or more of shafts 525A-B into a locked or actuated position. Hydraulic motor 560 may also be able to move one or more shafts 525A-B into an unlocked or stowed position.

FIG. 6 illustrates a top view of an actuated pneumatic fixation system and device 600 for articulating fifth wheel top plate 635. Top plate 635 may be attached to frame 685. Frame 685 may include pivots 675A-B this may allow top plate 635 to pivot. Generally, top plate 635 tilts downward towards the receiving end of top plate 635. Top plate 635 has a horseshoe shape where one end is opened to receive a king pin from a trailer (not depicted). The end of top plate 635 having the opening, in this context, is considered the receiving end.

Pneumatic fixation system and device 600 may include one or more levelers 695A and or 695B. Levelers 695A-B may be pneumatic cylinders that connect with or contact top plate 635 and may be used to lower and raise top plate 635. One or more of levelers 695A-B may attach to frame 685 or one or more may attach to tube 605. Additionally, one or more sensors 680A-B may be included to indicate when top plate 635 is raised to the appropriate height to appropriately actuate the pneumatic cylinder levelers 695A-B to position tube 605 in order to insert shafts 625A-B into keepers 690A-B. Sensors 680A-B each may include two parts. The first part of sensors 680A-B may be placed on one or more keepers 690A-B and the second part of sensors 680A-B may be placed on tube 605 as to be opposite the first part of sensors 680A-B. Sensors 680A-B are opposite on another when top plate 635 is in a position to properly actuate shafts 625A-B to slide into keepers 690A-B.

Alternatively, sensors 680A-B may be placed in various locations to help indicate the height of top plate 635. Tube 605 may include slots 610A-B that may be disposed in tube 605 and extend along the length of tube 605. Slots 610A-B may be positioned such that the distance between the proximal ends of slots 610A-B to the center of tube 605 is less than the distance between the distal ends of slots 610A-B and the ends of tube 605.

Grease fittings 630A-B may be attached to tube 605. Grease fitting 630A may be attached closer to a first end of tube 605 and grease fitting 630B may be attached closer to a second end of tube 605. Grease fittings 630A-B may be positioned as to be accessible to a grease gun or other grease application apparatuses while being in a position that does not hinder the operations of fifth wheel plate 635.

The hollow portion of tube 605 may allow shafts 625A-B to be positioned inside tube 605. The diameter of shafts 625A-B may be sized less than the diameter of the hollow portion of tube 605. The comparatively smaller diameter of shafts 625A-B may be sized to allow shafts 625A-B to slide back and forth along the length of tube 605. Shafts 625A-B may include locking points 640A-B. Locking points 640A-B, on shafts 625A-B, may be located on shafts 625A-B on an end opposite the end where handles 615A-B are attached to shafts 625A-B. Locking points 640A-B may include an aperture allowing a pin to be placed inside locking point 640A-B when shaft is positioned through keepers 690A-B to inhibit sliding. Alternatively, locking points 640A-B may include a groove disposed around the circumference of shafts 625A-B near an end of shafts 625A-B where a pin or ring is attachable to help shafts 625A-B to maintain position within their respective keepers 690A-B. Locking points 640A-B may attach shafts 625A-B to handles 615A-B to help prohibit shafts 625A-B from unintentionally moving to a stowed position. A stowed position in this context means moving one or more of shafts 625A-B from a keeper that helps inhibit a top plate from pivoting.

Attached to shafts 625A-B at an end opposite locking points 640A-B may be handles 615A-B respectively. Handles 615A-B may include connection end 635A-B that may be threaded to the connection ends found in shafts 625A-B that may also be threaded. At the distal end of handles 615A-B attachment points 620A-B may be included. Attachment points 620A-B are depicted as an aperture and can be used to link handle 615A to handle 615B. Attachment points 620A-B may help keep couplings 655A-B in position on handles 620A-B. Couplings 655A-B may connect to pneumatic cylinders 645A-B. Pneumatic cylinders 645A-B may connect to a first end of rods 650A-B respectively. The second end of rods 650A-B connect to couplings 655A-B that in turn connect to Handles 645A-B. Pneumatic cylinders 645A-B may further connect to port valves 665A-B by way of air hoses. Pneumatic cylinders 645A-B may be one or more of single-acting and double-acting telescopic cylinders. Port valves 665A-B may further connect to one or more air compressor 660 by way of air hoses. Air compressor 660 may include a connection 670 to a power source.

Handle 615A may attach to a proximal end of shaft 625A. Similarly, handle 615B may attach to a proximal end of shaft 625B. Handles 615A-B may have a diameter that is less than the width of slots 610A and 610B allowing the handles to slide back and forth along the length of slots 610A-B respectively. Slots 610A-B may include deviating channels that extend in a direction that is different than along the length of tube 605. These deviating channels may help to maintain handles 615A-B in a stowed and/or an actuated position. Attachment points 620A-B may be disposed on handles 615A-B respectively. Attachment points 620 may be disposed on handles 615A-B on a first end. Handles 615A-B may attach to shafts 625A-B on a second end. Attachment point 620 may include a groove disposed around the circumference of handles 615A-B to facilitate the attachment of a ring or a clip. Attachment points 620A-B may aid in attaching handle 615A to handle 615B together to help prevent shafts 625A-B from unintentionally deploying to an actuated position.

In an alternate version of FIG. 6 air compressor 660 may be an electric motor that connects to one or more electric piston 648A-B. Electric motor 660 when activated may move one or more of shafts 625A-B into a locked or actuated position. Electric motor 660 may also be able to move one or more shafts 625A-B into an unlocked or stowed position.

In an alternate version of FIG. 6 air compressor 660 may be a hydraulic motor that connects to one or more hydraulic piston 648A-B. Hydraulic motor 660 when activated may move one or more of shafts 625A-B into a locked or actuated position. Hydraulic motor 660 may also be able to move one or more shafts 625A-B into an unlocked or stowed position.

FIG. 7 illustrates a side view of an attached fixation system and device 700 for an articulating fifth wheel top plate 735. Because FIG. 7 illustrates a side view many aspects of system and device 700 may be hidden from view. Please note elements depicted in FIGS. 1-6 may be incorporated into FIG. 7. Top plate 735 may be attached to frame 785. Frame 785 may be part of or attached to a vehicle. Frame 785 may include pivots 775A-B which may allow top plate 735 to pivot. Pneumatic fixation system and device 700 may include one or more levelers 795. Leveler 795 may be a pneumatic cylinder that includes rod 750 which connects with or contacts top plate 735 using rod head 755 and may be used to lower and raise top plate 735. Leveler 795 may work in combination with one or more additional levelers. One or more of levelers, including leveler 795, may attach to frame 785 or may attach to tube 705. Additionally, one or more sensors 780, may be included to indicate when top plate 735 is raised to the appropriate height to actuate the pneumatic cylinder leveler 795 to position tube 705 in order to insert shaft 725 into keeper 790. Leveler 795 may be connected to a port valve not seen due to perspective that may connect to an air compressor 760. Other hoses 735A may also connect to air compressor 760. Multiple parts in fixation system and device 700 may be included but not seen due to perspective. These parts may be viewed on FIGS. 1-6. Sensors 780 may include two parts. The first part of sensors 780 may be placed on one or more keepers 790 and the second part of sensors 780 may be placed on tube 705 as to be opposite the first part of sensors 780 when in the appropriate position to activate shaft 725.

Shaft 725 may include locking point 740. Locking point 740 may be located on shaft 725 on an end opposite the end where handle 715 is attached to shaft 725. For a different view of attachment see FIGS. 3-5. Locking point 740 may include an aperture allowing a pin to be placed inside locking point 740 when shaft 735 is positioned through keeper 790 to inhibit sliding. Alternatively, locking point 740 may include a groove disposed around the circumference of shaft 725 near an end of shaft 725 where a pin or ring is attachable. Attachment point 720 may be used to attach shaft 725 to help prohibit shaft 725 from unintentionally moving to a stowed position. A stowed position in this context means moving one or more of shaft 725 from a keeper 790 that helps inhibit a top plate from pivoting.

Attached to shaft 725 at an end opposite locking point 740 may include handle 715. At the distal end of handle 715 may include attachment point 720. Attachment point 720 is depicted as an aperture and can be used to link handle 715 and to another handle. Attachment point 720 may be used to help keep couplings in position on handle 720 as depicted in FIGS. 5 and 6.

Handle 715 may be attached to a proximal end of shaft 725. Attachment point 720 may be an aperture disposed towards an end opposite the end that attaches to shaft 710. Attachment point 720 may also include a ring attached to handle 715. Handle 715 may include a groove disposed around the circumference of handle 715. Attachment point 720 may attach handle 715 to help prohibit shaft 725 from unintentionally deploying to an actuated position.

The controlling the pneumatic rising and lowering of the top plate depicted in FIGS. 5-7 may be positioned inside the cab of the vehicle. Alternatively, the pneumatic controls may be placed on the outside of the cab of the vehicle or a combination of both the outside and inside of the cab. In an alternate version of FIG. 7 air compressor 760 may be an electric motor that connects to one or more electric piston 748A-B. Electric motor 660 when activated may move one or more of shafts 725A-B into a locked or actuated position. Electric motor 760 may also be able to move one or more shafts 725A-B into an unlocked or stowed position. Moreover the one or more leveler 795 may be activated electrically.

In an alternate version of FIG. 7 air compressor 760 may be a hydraulic motor that connects to one or more hydraulic piston 748A-B. Hydraulic motor 760 when activated may move one or more of shafts 725A-B into a locked or actuated position. Hydraulic motor 760 may also be able to move one or more shafts 725A-B into an unlocked or stowed position. Moreover the one or more leveler 795 may be activated hydraulically.

While various embodiments of the present disclosure have been described above, it should be understood that they have been presented by way of example only, and not limitation. For example, anywhere it is mentioned that a pneumatic system was used this could be substituted with a hydraulic, electric, or other type of motorized system that would be known in the art. Further any combination of manual, pneumatic, hydraulic and/or electric systems may be used in combination with one another. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. An articulating fifth wheel fixation device comprising:
a tube attached to a fifth wheel top plate comprising:
a slot disposed along the length of the tube;
a shaft positioned inside a hollow portion of the tube comprising:
a handle attached to a first end of the shaft;
wherein the handle attached to the shaft extends outward beyond the outer circumferential edge of the tube through the slot.

2. The articulating fifth wheel fixation device of claim 1, further comprises:
a second shaft positioned inside a hollow portion of the tube.

3. The articulating fifth wheel fixation device of claim 2, wherein the tube further comprises:
a second slot disposed along the length of the tube.

4. The articulating fifth wheel fixation device of claim 3, wherein both slots are positioned in line with one another.

5. The articulating fifth wheel fixation device of claim 4, wherein the second shaft comprises:
a handle attached to a first end of the second shaft.

6. The articulating fifth wheel fixation device of claim 5, wherein when the fixation device is activated the handles are moved in opposite direction from one another.

7. The articulating fifth wheel fixation device of claim 6, wherein when the fixation device is deactivated the handles are moved towards one another.

8. The articulating fifth wheel fixation device of claim 7, wherein the handles further comprising:
locking points.

9. The articulating fifth wheel fixation device of claim 8, further comprises:
attachment pins that are sized to be placed in locking point when handles are positioned in a deactivated position.

10. A pneumatic fifth wheel fixation system comprising:
a compressor;
a pneumatic cylinder connected to the compressor;
a tube attached to a fifth wheel top plate comprising:
a slot disposed along the length of the tube;
a shaft positioned inside a hollow portion of the tube comprising:
a handle attached to a first end of the shaft;
wherein the handle attached to the shaft extends outward beyond the outer circumferential edge of the tube through the slot.

11. The pneumatic fifth wheel fixation system of claim 10, further comprises:
a second shaft positioned inside a hollow portion of the tube.

12. The pneumatic fifth wheel fixation system of claim 11, wherein the tube further comprises:
a second slot disposed along the length of the tube.

13. The pneumatic fifth wheel fixation system of claim 12, wherein both slots are positioned in line with one another.

14. The pneumatic fifth wheel fixation system of claim 13, wherein the second shaft comprises:
a handle attached to a first end of the second shaft.

15. The pneumatic fifth wheel fixation system of claim 14, wherein when the fixation device is activated the handles are moved in opposite direction from one another.

16. The pneumatic fifth wheel fixation system of claim 15, wherein when the fixation device is deactivated the handles are moved towards one another.

17. The pneumatic fifth wheel fixation system of claim 16, wherein the handles further comprising:
locking points.

18. The pneumatic fifth wheel fixation system of claim 17, further comprises:
attachment pins that are sized to be placed in locking point when handles are positioned in a deactivated position.

19. The pneumatic fifth wheel fixation system of claim 18, wherein the pneumatic cylinder is attached to the handle.

20. The pneumatic fifth wheel fixation system of claim 19, wherein the system further comprises:
a second pneumatic cylinder attached to the second handle.
